(19) United States
(12) Patent Application Publication
(10) Pub. No.: US 2018/0089248 A1
(43) Pub. Date: Mar. 29, 2018

(54) FABRIC SUPPORTED REPLICATION

(71) Applicant: Intel Corporation, Santa Clara, CA (US)

(72) Inventors: Francesc GUIM BERNAT, Barcelona (ES); Daniel A. RIVAS BARRAGAN, Köln (DE); Kshitij A. DOSHI, Tempe, AZ (US); Mark A. SCHMISSEUR, Phoenix, AZ (US); Steen LARSEN, Portland, OR (US)

(21) Appl. No.: 15/280,939

(22) Filed: Sep. 29, 2016

(51) Int. Cl. G06F 17/30

(52) U.S. Cl. CPC G06F 17/30345; G06F 17/30581

(57) ABSTRACT

Fabric supported replication enables hardware replication and hardware-assisted software replication of objects on behalf of replication software. Software specifies to a communication fabric of a storage system which objects to replicate and where and how to replicate them. A storage protocol defines which storage operations modify replicated objects. Alternatively, nodes in the communication fabric infer whether storage operations modify replicated objects. Either way, the fabric logic automatically propagates replicated objects and updates to replicated objects to replica nodes based on the software specification. The fabric logic initiates message flows between the replica nodes in order to perform the hardware replication and hardware-assisted software replication.

### TECHNICAL FIELD

The technical field relates generally to storage systems and, in particular, to storage replication systems.

### BACKGROUND ART

Storage systems protect against loss and inconsistency of stored data using various technologies. For example, storage systems use replication to maintain redundant copies (replicas) of stored data, particularly for stored data that is operationally critical. Existing replication solutions, such as Cinder, Trove, 3Par, etc., employ a variety of different services, tools and runtime options that provide differing replication capabilities in terms of the type of replication, i.e. snapshot vs. continuous, the number of replica peers, gradations of service quality, granularity of replication per volume, block, file, object and the like, and the type of architecture, such as master-slave or peer-peer, etc. But no matter how replication is provided, managing consistency among replicas is technically challenging.

For example, in a typical storage system employing a node architecture many objects are likely to be replicated among multiple nodes. In addition to node-based replication, in scale-out architectures files are typically replicated among multiple servers to enhance resiliency and reliability.

Other considerations affecting how replication is configured in a given operating environment include external requirements and constraints such as cost, availability, and load/risk balancing. For example, how objects are replicated among nodes can depend on factors such as high availability and performance. For high availability updates to replicated objects are typically propagated as fast as possible, whereas for performance updates can be propagated in batches.

Because of the technical challenges that arise during replication, managing replication using existing replication solutions can be costly. A significant portion of the cost is due to the need to maintain replication state information, such as which peer nodes are maintaining which object replicas, as well as the need to coordinate this information across applications that share object spaces.

### BRIEF DESCRIPTION OF THE DRAWINGS

The described embodiments are illustrated by way of example and not limitation in the figures of the accompanying drawings, in which like references indicate similar elements and in which:

FIG. 1 is a block diagram illustrating a general overview of fabric supported replication in accordance with one embodiment;

FIG. 2 is a block diagram illustrating a fabric supported replication node architecture, including an example of replica and monitoring data that can be used in accordance with one embodiment of fabric supported replication;

FIGS. 3-5 are flow diagrams illustrating embodiments of processes performed in a node in accordance with embodiments of fabric supported replication as shown in FIGS. 1 and 2;

FIG. 6 is a chart illustrating example estimates of the varying number of files that can be monitored by file size in accordance with embodiments of fabric supported replication as shown in FIGS. 1-5;

FIGS. 7-8 are examples of message flows generated in accordance with embodiments of fabric supported replication as shown in FIGS. 1-5; and

FIG. 9 illustrates an example of a typical computer system in which embodiments of fabric supported replication as described herein could be implemented, either in whole or in part.

Other features of the described embodiments will be apparent from the accompanying drawings and from the detailed description that follows.

### DESCRIPTION OF THE EMBODIMENTS

To address the challenges of managing replication of objects in existing storage management systems, the described embodiments provide hardware-assisted replication referred to herein as a fabric-supported replication.

As already noted, a significant portion of the cost in managing replication arises from the necessity of maintaining replication state information, such as which peer nodes are maintaining which object replicas, and coordinating this information across applications that share object spaces. The peer nodes include any client or server node in which objects are maintained in memory or in a storage repository. In current replication systems this task generally falls to proprietary replication software and the application spaces in which the objects are being accessed and updated.

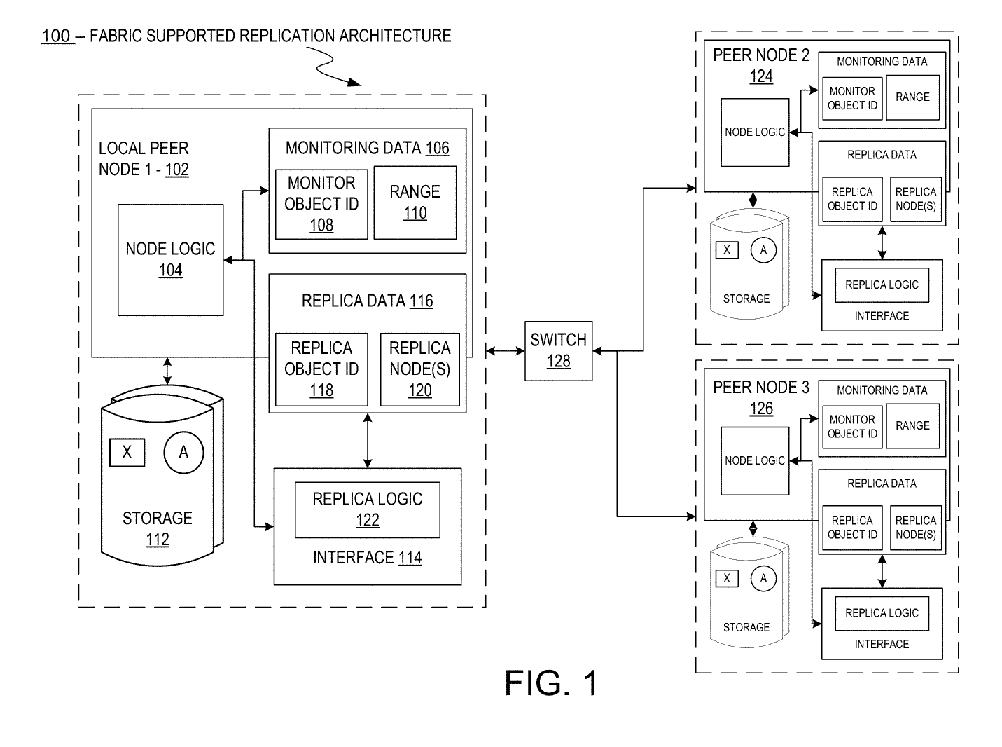

For example, using the values of exemplary nodes, objects and files illustrated in FIG. 1, if a client node 1 modifies object X, or file A, then replication software on client node 1 would need to look up stored replication information to determine whether to propagate object X and file A to peer nodes 2 and 3. If different application spaces on client node 1 are also modifying object X or file A, the look up would need to be repeated because it is not possible to share the results of the look up across application spaces. Moreover, at the software level in which the replication software operates, it would be difficult for the replication software to combine multiple updates from different application spaces to improve replication performance. Furthermore, should peer node 2 become temporarily unavailable, then the replication software would need to adjust the entire replication scheme, i.e. all of the replication information stored on all of the peer nodes, to insure that the multiple applications operating at peer nodes 1 and 3 are made aware of the unavailability of peer node 2.

In addition to maintaining replication state information indicating which peer nodes are maintaining replicas of an object or file, should an object be transformed between the application space and different storage representations (e.g., compressed, encrypted, delta differenced), then the replication software would have to apply the transformations at each peer node tailored to that node's particular storage representation.

Because of the myriad variations of replication software encountered in a typical storage management system, requiring high-level applications to implement or manage replication and transformation of replicated objects or files is neither efficient nor effective, particularly in large scale out systems. Additionally, such tasks may incur disproportionate costs for some objects, such as transaction logs, that can be heavily replicated. Even objects that are not heavily replicated, such as temporary or re-computable objects, may give rise to needless costs since such objects might not need to be replicated at all.

In view of the foregoing, in one embodiment, fabric-supported replication configures fabric replication logic in one or more fabric entities to manage object replication across one or more peer replica nodes. Fabric entities refer to any element in a communication fabric, where the communication fabric refers to the combination of hardware and software elements that facilitate communication between devices, including a node, a host machine, a host machine's host fabric interconnect (referred to herein as “interface”), a message flow, a protocol, and a switch, a router, a hub or other communication devices. In one embodiment, the interface refers to any hardware logic added to a node in a single coherent cache domain to support communications between that node and other nodes through channels that are collectively referred to as the fabric

One such interface is a host fabric interconnect, or HFI, a hardware interconnect between a node and the communication fabric connecting multiple nodes. Different hardware vendors employ their own hardware-specific HFIs, and typically employ proprietary protocols for use with their HFI. For example, the Intel® Scalable System Framework, or SSF, supports high performance computing (HPC) using a proprietary high-speed interconnect fabric for HPC server nodes, Intel® Omni-Path Architecture (OPA) http://www.intel.com/content/www/us/en/high-performance-computing-fabrics/omni-path-architecture-fabric-overview.html. Other vendors of proprietary high-speed interconnect fabric include the Mellanox high performance Switch-IB™.

A node includes any computing node or storage node in which an object is capable of being replicated. The object being replicated includes any one of a file, directory, database structures such as a table or a group of tuples, a set, or any other data that is meaningful in a software application and for which replication is possible.

In one embodiment, fabric supported replication advantageously reduces replication cost by configuring the fabric entities to perform hardware replication of the stored replicas of objects on behalf of application or replication software, collectively referred to herein as a software stack. In one embodiment, fabric supported replication advantageously reduces replication cost by configuring the fabric entities to perform hardware-assisted replication of stored or non-storage replicas of objects by notifying the software stack when, where and/or how the software stack can perform software replication of objects. Whether performed using hardware replication or hardware-assisted software replication, fabric supported replication reduces the coordination burden of replication on the software stack.

In one embodiment the fabric replication logic includes replica logic and node logic. The replica logic in each of one or more nodes identifies which objects are replicated across which nodes and initiates replication message flows among nodes as needed. The node logic is included in each of one or more nodes designated as replica nodes. The replica nodes include any node in which an object is replicated, including computing nodes and storage nodes. The node logic identifies when a replicated object has been modified in that replica node and generates a notification to the replica logic to initiate replication of the modified object at any one or more of the other nodes designated as replica nodes for the modified object.

In one embodiment, the fabric replication logic can be contained in each node's interface, such as a node's interconnect to the host fabric, the node itself, and/or implemented in a storage subsystem extension to the node's interface or other location as long as the fabric replication logic is uniformly available at each point in a storage system where objects can be replicated. In one embodiment, the replica logic in each of the one or more nodes is contained in each node's interface. In one embodiment, the node logic in each of the one or more replica nodes is contained in any one or more of the core execution components in each node, including the node central processing units (CPUs), home agents, memory controllers, Input/Output (I/O) hubs, etc.

In one embodiment, the replica logic receives from a client node an initial software designation of one or more replica peers for the object where replica peers can be any of the nodes in the communication fabric capable of performing replication. The client node can be any application space of a host machine. In one embodiment the initial software designation is relayed from the software stack to the node in a registration message that identifies the replicated object and the one or more designated replica peers. Upon receipt of the registration message, the replica logic causes the replicated object's designated replica peers to be registered at the recipient node, i.e. the node that receives the registration message, and relays the registration message to each of the one or more designated replica peer nodes for registration at each respective node. Alternatively, or in addition, the software stack can send or broadcast the registration message directly to each of the one or more designated replica peer nodes.

In one embodiment, the replica logic registers the replicated object's designated replica peers by generating an entry in a replication data structure that maps a replicated object to a list of the one or more designated replica peers. In one embodiment, the list of the one or more replica peers in the replication data structure is automatically updated over time to reflect changes in the replication status of an object.

In one embodiment, the replication data structure can be any data structure that scalably translates the replicated object to the list of the one or more replica peers that maintain a replica of the object. For example, the replication data structure could be implemented in data structures that scalably translate the replicated object to its corresponding replica peers such as a multi-level map, a hash table, a bloom filter and the like. In one embodiment the replication data structure is stored in content addressable memory (CAM) such that frequently updated objects are stored in a CAM cache while infrequently updated objects are stored in a node's interface in a walkable map that is similar to an address translation table but uses a tree data structure instead of a table data structure.

In one embodiment, the replication status of an object can change when a replica peer is deregistered because it is no longer replicating the object, including situations in which the replica peer node is no longer in service or is temporarily inaccessible. In one embodiment, the software stack may directly remove from replication an object or one of the object's designated replica peers by sending an updated registration or deregistration message to one or more of the affected replica peer nodes, including sending a broadcast message to all or one or more of the affected replica peer nodes.

In one embodiment, upon receiving the initial designation of one or more replica peers for an object, the replica logic notifies the node logic that the object is being replicated. Responsive to the notification, the node logic optionally registers the object as a monitored object to facilitate detecting operations in the node that modify the monitored object, whether the modification to the object is a modification of the object in storage or a modification of the object in memory.

In one embodiment, detecting operations that modify the monitored object is performed using an interface to the node's storage devices to automatically intercept operations that can modify monitored objects. For example, in one embodiment, the node logic implements a storage protocol that explicitly identifies an operation that is modifying a monitored object.

In one embodiment, the node logic is configured to intercept operations targeting a set of objects, and to infer therefrom whether the intercepted operation maps to a monitored object. For example, the node logic can infer the occurrence of an operation modifying a monitored object using a hardware filter, such as a bloom filter, to determine whether the operation is included in a range filter identifying operations targeting a set of objects that include the monitored object. In one embodiment, other techniques may be employed that enable the node logic to map an intercepted operation to a monitored object as long as the performance impact on the operation of the node is reasonably small.

In one embodiment, once the node logic has detected that a monitored object has been changed, the node logic issues a notification to the replica logic to initiate replication of the monitored object, i.e. to propagate the modification of the monitored object to its replica peer nodes. In one embodiment, responsive to the notification the replica logic determines from the replication data structure which replica peer nodes are currently registered for the monitored object. The replica logic then generates a replication message flow to each of the one or more replica peer nodes currently registered for the monitored object. In one embodiment, the replica logic generates the message flow to the software stack instead of or in addition to the replica peer nodes to assist the software stack in performing replication of the monitored object.

In one embodiment, the replica logic generates the message flow in accordance with replica metadata accessible to the replica logic, including whether the replication is to be performed immediately or in batch mode at predefined time or data intervals. In batch mode, the message flow is aggregated over the predefined interval to include all replication data accumulated since sending the last batch notification.

In one embodiment, the replica metadata accessible to the replica logic is configured in response to replication parameters provided or updated by the software stack before, during or after registration of replicated objects and their designated replica peers. In one embodiment, the replication metadata specifies whether to perform hardware replication, software replication, or a combination of both hardware and software replication on a per replicated object basis or for multiple replicated objects and replica peers.

In one embodiment, in addition to offloading replication tasks from the software stack to the communication fabric, the fabric-supported replication advantageously avoids operating system software overheads in such secondary operations as interrupts, reads and writes. For example, in a typical replication server a substantial amount of processor time is spent in the system software stack to process network messages and store them into persistent storage. Replicated objects can be stored in non-volatile memory or in storage devices. Non-volatile memory is a storage medium that does not require power to maintain the state of data stored by the medium. Non-limiting examples of nonvolatile memory may include any or a combination of: solid state memory (such as planar or 3D NAND flash memory or NOR flash memory), 3D crosspoint memory, storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), other various types of non-volatile random access memories (RAMs), and magnetic storage memory. In some embodiments, 3D crosspoint memory may comprise a transistor-less stackable cross point architecture in which memory cells sit at the intersection of words lines and bit lines and are individually addressable and in which bit storage is based on a change in bulk resistance. In particular embodiments, a memory module with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org).

In one embodiment, fabric-supported replication uses channels at each receiving node's interface to automatically apply modifications to stored and non-volatile memory replicas of replicated objects while the application and replication software stack manage replication of non-storage replicas, where non-storage replicas refer to replicated objects in an application space. This reduces the amount of processor time that needs to be spent in the system software stack by reducing the number of network messages.

In the description that follows, examples may include subject matter such as a method, a process, a means for performing acts of the method or process, an apparatus, a node, and a system for a fabric supported replication, and at least one machine-readable tangible storage medium including instructions that, when performed by a machine or processor, cause the machine or processor to performs acts of the method or process according to embodiments and examples described herein.

Numerous specific details are set forth to provide a thorough explanation of embodiments of the methods, media and systems for providing fabric supported replication. It will be apparent, however, to one skilled in the art, that an embodiment can be practiced without one or more of these specific details. In other instances, well-known components, structures, and techniques have not been shown in detail so as to not obscure the understanding of this description.

Reference in the specification to “one embodiment” or “an embodiment” means that a particular feature, structure, or characteristic described in connection with the embodiment can be included in at least one embodiment. The appearances of the phrase “in one embodiment” in various places in the specification do not necessarily all refer to the same embodiment.

The methods, processes and logic depicted in the figures that follow can comprise hardware (e.g. circuitry, dedicated logic, fabric, etc.), software (such as is run on a general-purpose computer system or a dedicated machine, e.g. a switch, a node, a forwarding device), and interfaces (such as the interconnect to a node's host fabric or an application programming interface (“API”)) between hardware and software, or a combination of both. Although the processes and logic are described below in terms of some sequential operations, it should be appreciated that some of the operations described can be performed in a different order. Moreover, some operations can be performed in parallel rather than sequentially.

In any one or more of the embodiments of the systems, apparatuses and methods herein described, a communication fabric of a storage system for storing objects at any one or more of a plurality of nodes receives a specification of an object and one or more replica peers to which the object is replicated, the replica peers specified from among the plurality of nodes, and replicates the object to the one or more replica peers.

In any one or more of the embodiments of the systems, apparatuses and methods herein described, the communication fabric detects a modification of a replicated object in a node of the one or more replica peers specified from among the plurality of nodes, notifies the one or more replica peers that the modification of the replicated object was detected, and replicates the modification of the replicated object to a corresponding replicated object at the one or more replica peers.

In any one or more of the embodiments of the systems, apparatuses and methods herein described, the communication fabric notifies the one or more replica peers that the modification of the replicated object was detected by any one or more of notifying a host fabric interconnect (referred to herein as an “interface”) of the node that the modification of the replicated object was detected, determining the one or more replica peers to which the replicated object is replicated, and notifying, via the notified node's interface, each other node of the determined one or more replica peers that the modification of the replicated object was detected.

In any one or more of the embodiments of the systems, apparatuses and methods herein described, the communication fabric replicates the modification of the replicated object to the corresponding replicated object at the one or more replica peers by any one or more of applying the modification to the corresponding replicated object at each of the one or more replica peers, and replacing the corresponding replicated object at each of the one or more replica peers with the replicated object at the node in which the modification was detected.

In any one or more of the embodiments of the systems, apparatuses and methods herein described, the communication fabric replicates the modification of the replicated object to the corresponding replicated object at the one or more replica peers in accordance with a replica metadata, the replica metadata specifying one or more options for performing replicating, including any one or more of performing replicating immediately upon detecting the modification of the replicated object, performing replicating after aggregating one or more modifications of one or more replicated objects within a specified time interval, performing replicating by applying the modification at the replica peer, performing replicating by replacing the replicated object at the replica peer, and performing replicating in a software stack in communication with the replica peer.

In any one or more of the embodiments of the systems, apparatuses and methods herein described, the specification of the object and the one or more replica peers to which the object is replicated is a registration message received in one node of the plurality of nodes, the registration message originating in a software stack in communication with the node.

In any one or more of the embodiments of the systems, apparatuses and methods herein described, the communication fabric updates the specification of the one or more replica peers to which the object is replicated via messages exchanged between the replica peers, wherein updating the specification of the one or more replica peers includes removing a specified one of the one or more replica peers from replication.

In any one or more of the embodiments of the systems, apparatuses and methods herein described, a node is in communication with a plurality of nodes, each node having a memory and a processor, and the processor is configured to receive a specification of an object and one or more replica peers to which the object is replicated, the replica peers specified from among the plurality of nodes. The processor is further configured to store the specification in a replication data structure mapping the object to the one or more replica peers, replicate the replication data structure to the one or more replica peers, and replicate the object to the one or more replica peers.

In any one or more of the embodiments of the systems, apparatuses and methods herein described, the processor is further configured to notify the one or more replica peers that a modification of a replicated object was detected, and to replicate the modification of the replicated object to a corresponding replicated object at the one or more replica peers.

In any one or more of the embodiments of the systems, apparatuses and methods herein described, an interface to the host fabric in each node of the plurality of nodes supports communications between the nodes and is configured to access the replication data structure mapping the replicated object that was modified to the object's one or more replica peers and notify each node of the object's one or more replica peers that the modification of the replicated object was detected.

In any one or more of the embodiments of the systems, apparatuses and methods herein described, the processor is configured to replicate the modification of the replicated object to the corresponding replicated object at the one or more replica peers, including applying the modification to the corresponding replicated object at each of the one or more replica peers or replacing the corresponding replicated object at each of the one or more replica peers with the replicated object at the node in which the modification was detected.

In any one or more of the embodiments of the systems, apparatuses and methods herein described, the processor is configured to replicate the modification of the replicated object to the corresponding replicated object at the one or more replica peers, including receiving, along with the specification of the object and the one or more replica peers to which the object is replicated, a replica metadata, the replica metadata specifying one or more options for replicating, including any one or more of options to replicate immediately upon detecting the modification of the replicated object, replicate after aggregating one or more modifications of one or more replicated objects within a specified time interval, replicate by applying the modification at the replica peer, replicate by replacing the replicated object at the replica peer, and replicate in a software stack in communication with the replica peer.

In any one or more of the embodiments of the systems, apparatuses and methods herein described, the specification of the object and the one or more replica peers to which the object is replicated is a registration message received in one node of the plurality of nodes, the registration message originating in a software stack in communication with the node.

In any one or more of the embodiments of the systems, apparatuses and methods herein described, the processor is further configured to update the specification of the one or more replica peers to which the object is replicated via messages exchanged between the replica peers, wherein updating the specification of the one or more replica peers includes removing a specified one of the one or more replica peers from replication.

In any one or more of the embodiments of the systems, apparatuses and methods herein described, a fabric supported replication comprises means for storing objects at any one or more of a plurality of nodes, means for a communication fabric having a means for communicating between the plurality of nodes, means for specifying to the communication fabric an object and one or more replica peers to which the object is replicated, including means for specifying the replica peers from among the plurality of nodes, and means for replicating the object to the one or more replica peers via the means for communicating between the plurality of nodes of the communication fabric.

In any one or more of the embodiments of the systems, apparatuses and methods herein described, a fabric supported replication further comprises means for detecting a modification of a replicated object in a node of the one or more replica peers specified from among the plurality of nodes, means for notifying the one or more replica peers that the modification of the replicated object was detected, and means for replicating the modification of the replicated object to a corresponding replicated object at the one or more replica peers via the means for communicating between the plurality of nodes of the communication fabric.

In any one or more of the embodiments of the systems, apparatuses and methods herein described, the means for notifying the one or more replica peers that the modification of the replicated object was detected includes a means for an interface to each node of the plurality of nodes of the communication fabric, means for notifying the means for the interface of the node in which the modification was detected, means for the interface to determine the one or more replica peers to which the replicated object is replicated, and means for the interface to notify each node of the determined one or more replica peers that the modification of the replicated object was detected.

In any one or more of the embodiments of the systems, apparatuses and methods herein described, the means for replicating the modification of the replicated object to the corresponding replicated object at the one or more replica peers includes any one of means for applying the modification to the corresponding replicated object at each of the one or more replica peers and means for replacing the corresponding replicated object at each of the one or more replica peers with the replicated object at the node in which the modification was detected.

In any one or more of the embodiments of the systems, apparatuses and methods herein described, the means for replicating the modification of the replicated object to the corresponding replicated object at the one or more replica peers is performed in accordance with a replica metadata, the replica metadata specifying one or more options for performing replicating, including any one or more of means for performing replicating immediately upon detecting the modification of the replicated object, means for performing replicating after aggregating one or more modifications of one or more replicated objects within a specified time interval, means for performing replicating by applying the modification at the replica peer, means for performing replicating by replacing the replicated object at the replica peer, and means for performing replicating in a software stack in communication with the replica peer.

In any one or more of the embodiments of the systems, apparatuses and methods herein described, the means for specifying the object and the one or more replica peers to which the object is replicated includes a means for processing a registration message received in one node of the plurality of nodes, the registration message originating in a software stack in communication with the node.

In any one or more of the embodiments of the systems, apparatuses and methods herein described, the means for updating the specification of the one or more replica peers to which the object is replicated including means for exchanging messages between the replica peers, wherein the means for updating the specification of the one or more replica peers includes a means for removing a specified one of the one or more replica peers from replication.

In one embodiment, at least one computer-readable storage medium includes instructions that, when executed on one or more processors of any one or more of the switches, nodes, clients, servers and interfaces cause the processor(s) to perform any one or more of the embodiments of the systems, apparatuses and methods for fabric supported replication herein described.

FIG. 1 is a block diagram illustrating one embodiment of fabric-supported replication, including an architectural overview 100 employing multiple replica peer nodes 102/124/126 in communication via switch 128. It should be noted that the number of nodes and switches illustrated in FIG. 1 and elsewhere in this description is by way of example only; the number of nodes, switches, storage units 112 and the like can vary considerably depending on the implementation.

In the illustrated embodiment of FIG. 1, a local peer node 102 includes storage units 112 having stored thereon replicated data such as an object X and a file A. A peer node is any computing node in communication with other peer nodes without mediation by a server or other centralized interface. The local peer node 102 communicates with its interface 114 to the host fabric, such as a host fabric interconnect, and with replica logic 122 when determining whether to replicate object X and file A to replica peer node 2 124 and replica peer node 3 126. In one embodiment, to make this determination the replica logic 122 references the replica data 116 in which is stored a replica object ID 118 for each replicated object and the corresponding one or more replica node(s) 120.

In one embodiment, the architecture of the nodes participating in fabric-supported replication includes a node logic 104 and monitoring data 106 composed of the object identifiers (object ID) of monitored objects 108, i.e. replicated objects that the node is monitoring for changes, and a range 110 or other indicator that enables the node logic 104 to determine whether storage operations intercepted from or to the storage units 112 have resulted in changes to the monitored object 108. If so, then the node logic 104 generates a notification to the replica logic 122 to initiate a replication message flow for the monitored object 108. In response the replica logic 122 looks up the corresponding replica object ID 118 matching the object ID of the monitored object 108, and generates the message flow to one or more replica peer nodes 2 and 3 124/126 in accordance with the designated replica nodes 120 to which the replica object ID 118 corresponds.

For ease of illustration, and by way of example only, the fabric supported replication architecture in FIG. 1 shows three peer nodes 1, 2 and 3 (102/124/126) in communication with one another and one object and one file. Of course, in a typical embodiment, the number of nodes or other fabric entities participating in fabric supported replication can be much larger and can provide storage replication services for a great variety of data and not just objects and files. In addition other arrangements of fabric components can be used to provide fabric supported replication, such as master-slave

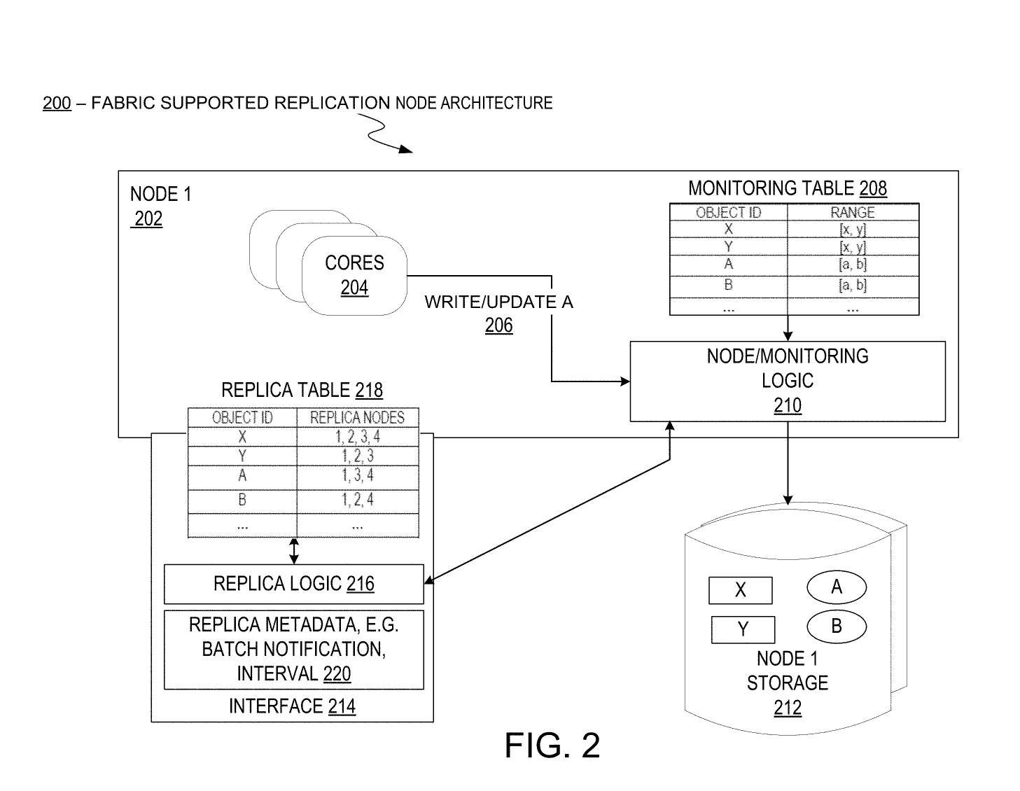

FIG. 2 is a block diagram illustrating an embodiment of fabric-supported replication in further detail. In particular, FIG. 2 illustrates exemplary node architecture 200 of the peer nodes introduced in FIG. 1 (peer nodes 102/124/126).

As illustrated, a node 1 202 includes multiple cores 204 capable of generating operations that can affect objects in node 1 storage 212, such as object X and Y and files A and B. In response to receiving from the software stack a specification of objects to be replicated and a list of replica nodes to which such objects are to be replicated, replica logic 216 configures a replica data structure such as replica table 218 with entries that map the object ID of the objects being replicated with their respective lists of replica nodes. As shown in the illustrated example, object X is mapped to replica nodes 1, 2, 3 and 4, object Y is mapped to replica nodes 1, 2 and 3, file A is mapped to replica nodes 1, 3 and 4, and file B is mapped to replica nodes 1, 2 and 4, and so forth. For ease of illustration and by way of example only the replication data in illustrated in FIG. 2 includes objects and files. Of course, other types of data can be replicated using fabric-supported replication, such as database tables, data sets and the like.

In one embodiment, in response to receiving from the software stack of an application operating in a node, an optional specification of replica metadata, replica logic 216 configures replica metadata 220 to contain the specified information. The specification includes replica metadata that indicates whether to replicate the specified objects in batches, intervals between batches, or whether to replicate immediately after updates to a replicated object. When the optional specification of replica metadata is not received, the replica logic 216 configures a default replication specification, such as immediate replication. In one embodiment, the replica logic 216, replica table 218 and replica metadata 220 are in the node's interface 214.

In one embodiment, in response to receiving from the software stack the specification of the objects to be replicated, the replica logic 216 notifies the node logic 210 to monitor the specified objects. In one embodiment, the specification of the objects to be replicated is contained in a single message specifying multiple objects or the specification of the objects to be replicated is contained in a separate message for each object. In one embodiment, to monitor the specified objects (or files), the node logic generates a monitoring data structure, such as monitoring table 208, to map the specified objects to various storage operations capable of modifying the specified objects. In the illustrated example, objects X and Y can be mapped to a range of operations [x, y] that target objects X and Y. Likewise, files A and B can be mapped to a range of operations [a, b] that target files A and B. During operation of Node 1, whenever node logic 210 encounters operations specified in the monitoring table 208, the node logic detects whether the specified object has been modified.

In one embodiment, node logic 210 implements a storage protocol that explicitly identifies when a specified object is modified by a storage operation. For example, node logic 210 can intercept a write/update operation 206 from core 204 for specified file A which explicitly identifies that file A is being modified on Node 1 storage 212.

During operation, should node logic 210 determine that a specified object has been modified, such as file A, then node logic 210 notifies replica logic 216. In turn, replica logic 216 looks up the list of replica nodes 1, 3 and 4 to which file A has been mapped, and generates notifications to those replica nodes to initiate replication. In one embodiment, replica logic 216 generates the notifications in accordance with the optionally specified replica metadata 220. For example, if replica metadata 220 indicates that replication is to be performed in batches, replica logic will wait to receive additional notifications from node logic 210 that specified objects have been modified before generating the notifications to the respective replica nodes.

In one embodiment, notifications to the replica nodes can incorporate the modifications to the specified object along with the notification, so that each of the replica nodes receives and applies the same modification, referred to herein as an in-band update, or fabric assisted hardware replication because it uses an in-band channel established among the interfaces of each of the replica nodes. Alternatively, in one embodiment, the software stack at the receiving replica nodes, such as replica nodes 3 and 4 for modified file A, is responsible for invalidating local replicas of file A and replacing them with the new modified copy of file A from the node generating the notification, in this case Node 1 202. This type of replication is referred to herein as discard and replace, or fabric assisted software replication. In one embodiment, both options for notifications can be employed. For example, in-band notifications are typically used for small modifications to replicated objects, and discard-and-replace notifications are used for large modifications to replicated objects. Examples of large modifications can be in the range of 100 MB to GBs.

During operation, should node 3 be removed as a replica node for file A, such as by going out of service, the node 3 will respond to the notification with a non-acknowledgment message, or NACK. In response to the NACK, the replica logic 216 that generated the notification responds by pruning the list of replica nodes for file A to remove node 3. Conversely, when a new node, such as new node 4 is added to the list of replica nodes to which file A is to be replicated, each of the nodes 1, 2, 3 and 4 is updated with a replica list to reflect the addition of node 4. In one embodiment, pruning and updating includes deletions, changes and additions to the replica table 218. In one embodiment, any updates to the list of replica nodes in replica table 218 can be propagated automatically to all other replica peer nodes using the same notification process that is used to replicate the modified replicated objects.

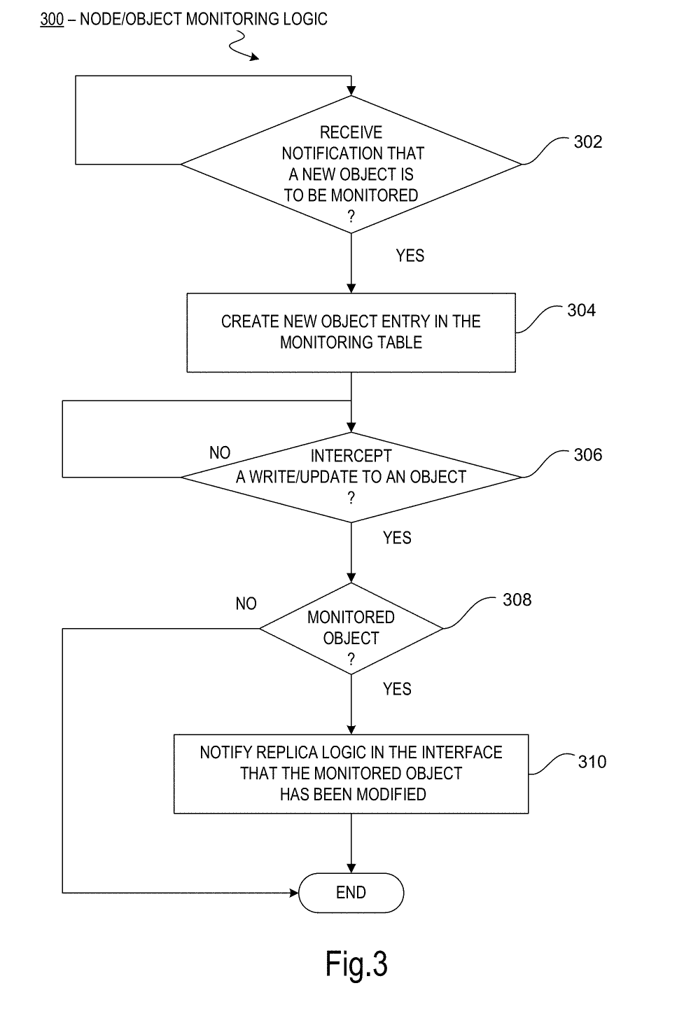

FIGS. 3-5 are flow diagrams illustrating embodiments of processes performed in a node in accordance with embodiments of fabric-supported replication as shown in FIGS. 1 and 2. FIG. 3 illustrates a summary overview of a process 300 for the node logic to monitor replicated objects to detect modifications.

In one embodiment, at decision block 302, if the node logic receives a notification from the node's interface that a new object is to be monitored, the node logic performs process 304 to register the object for monitoring by optionally creating a new object entry in the monitoring table. In one embodiment, the monitoring table is a bloom filter or other type of data structure that can detect when objects are modified based on the bloom filter's range for the node in which it is implemented. The range is a subset of the values in the bloom filter.

Alternatively, in one embodiment, the node logic implements a storage protocol that directly identifies objects modified by storage operations, such as by including the object's unique identifier for storage operations that modify objects, e.g. write operations where the object's unique identifier is a bit value such as a universally unique identifier (UUID). In one embodiment, the node logic can implement a network attached storage (NAS) protocol that directly identifies objects modified by storage operations, such as when the node only provides the storage facility.

In one embodiment, at decision blocks 306/308, the node logic intercepts such an operation, for example a write/update operation to a replicated object previously registered for monitoring. At process 310, the node logic notifies the replica logic in the node's interface that the monitored object has been modified.

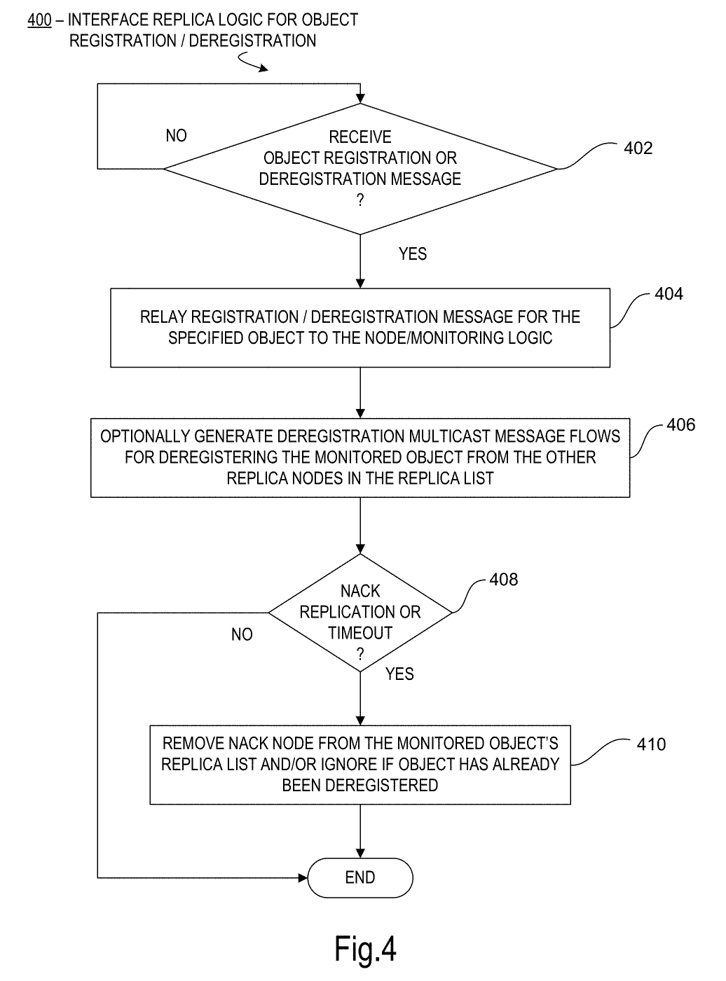

FIG. 4 illustrates a summary overview of a process 400 for the replica logic to register and deregister objects for fabric-supported replication. At decision block 402, the replica logic determines that it has received an object registration message or deregistration message. In a typical embodiment, the registration or deregistration message specifies the replicated object and the nodes to which the object is replicated, and is received from the software stack. In one embodiment, the messages can be received from other replica nodes participating in fabric-supported replication. In either case, at process 404, the messages for the specified replicated objects are relayed to the node logic for further processing.

In one embodiment, at process 406 the messages for the specified object are optionally relayed to the other replica nodes specified in the message and processed in order to generate or update the replica table mapping the replicated objects to their respective replica nodes as needed. At decision block 408, should the replica logic receive a non-acknowledgment message from another replica node, or if a message sent to another replica node times out, then at process 410 the replica logic proceeds to remove the unresponsive replica node from the list of replica nodes to which the specified object is to be replicated.

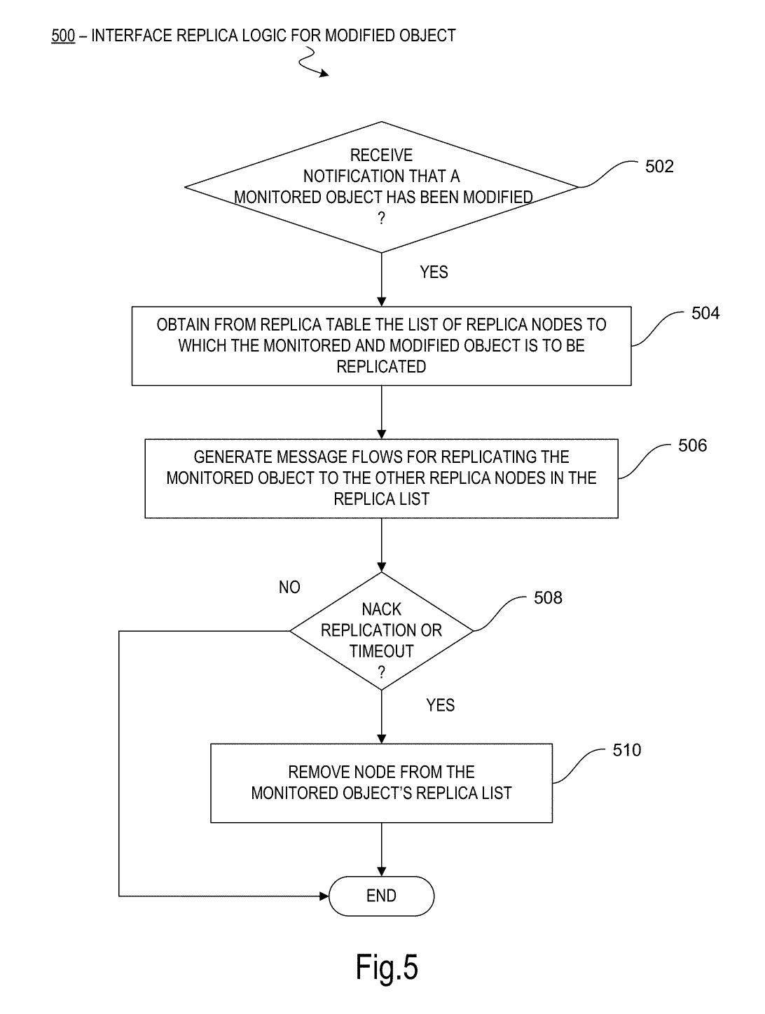

FIG. 5 illustrates a summary overview of another process 500 for the replica logic. At decision block 502 upon receiving a notification that an object has been modified, the replica logic performs a process 504 to obtain from the replica table the list of replica nodes to which the modified object is to be replicated. For example, in one embodiment, the replica logic in the node's interface looks up the object ID of the modified object (as provided by the node logic) and extracts the list of replica nodes to which the object is to be replicated. At process 506, the replica logic uses the extracted information to generate the message flows for replicating the monitored object to the replica nodes in the list.

In one embodiment, at decision block 508, should the replica logic receive a non-acknowledgment message from one of the replica nodes to which the message flows were transmitted, or if the message flow to a replica node times out, then at process 510 the replica logic proceeds to remove the unresponsive replica node from the list of replica nodes to which the monitored object is to be replicated.

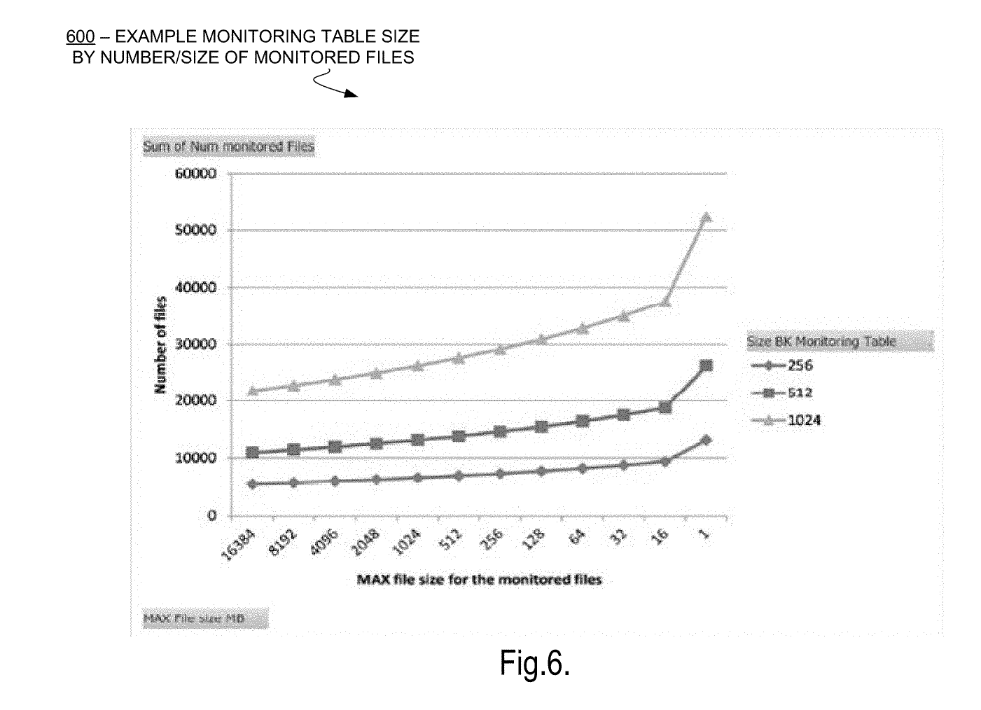

FIG. 6 is a chart illustrating example estimates of the varying number of files that can be monitored by file size in a given node in accordance with embodiments of fabric supported replication as shown and described with reference to FIGS. 1-5. As shown in chart 600, the number of files than can be monitored for fabric supported replication depends on the maximum size of the monitoring table and monitoring logic incorporated into the node logic. The chart 600 illustrates estimates of the number of files that can be monitored by node logic for different sizes of the monitoring table, e.g. from 256 KB up to 1 MB, and for different maximum file sizes. In this example, fabric supported replication can monitor approximately 5.4K files for maximum files sizes up to 16 GB using a monitoring table of 256 KB, and approximately 52K files for maximum file sizes up to 1 MB using a monitoring table of 1 MB. The average of all the estimated data points is approximately 20K files as a point of reference for estimating the scalability of fabric supported replication on a per node basis.

In one embodiment, the estimated number of files that can be monitored for fabric supported replication is dependent only on the size of monitoring table, and is not dependent on the maximum files sizes of the files being replicated. For example, in one embodiment the software stack explicitly conveys marker-based information to the node's interface that the software stack has modified a particular object. Instead of the node logic using the monitoring table to infer that a storage operation refers to a monitored object X, the software stack instead uses a storage protocol that wraps the modification to object X between explicit messages to the node's interface that the object has been modified. When the software stack sends a message to the node logic in the node's interface, the message explicitly indicates that monitored object X has been modified.

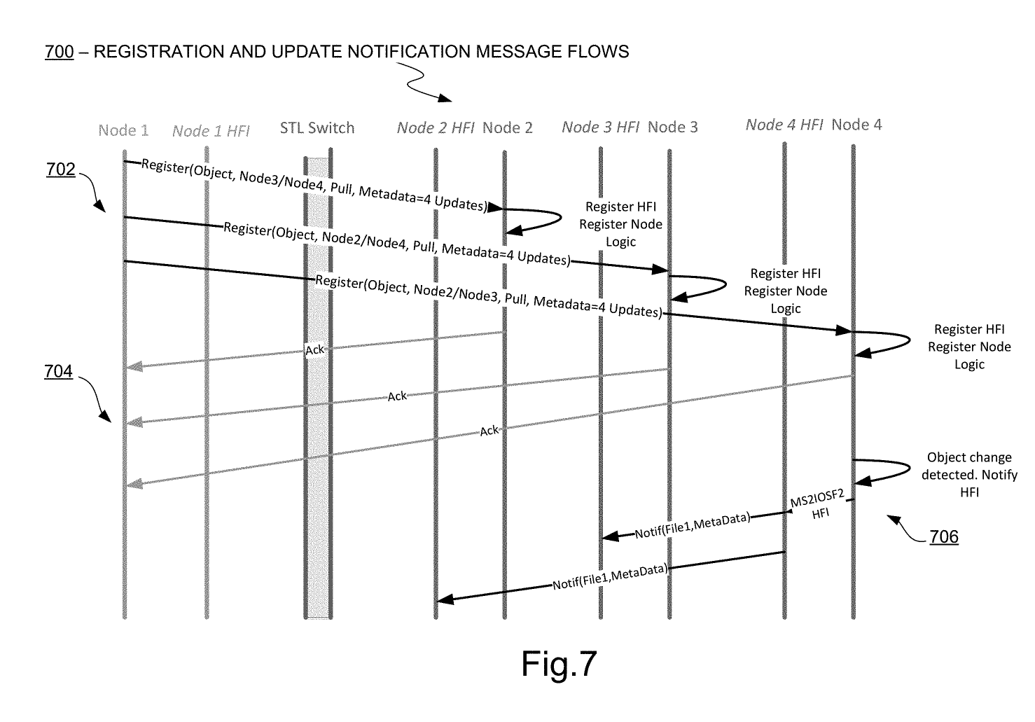

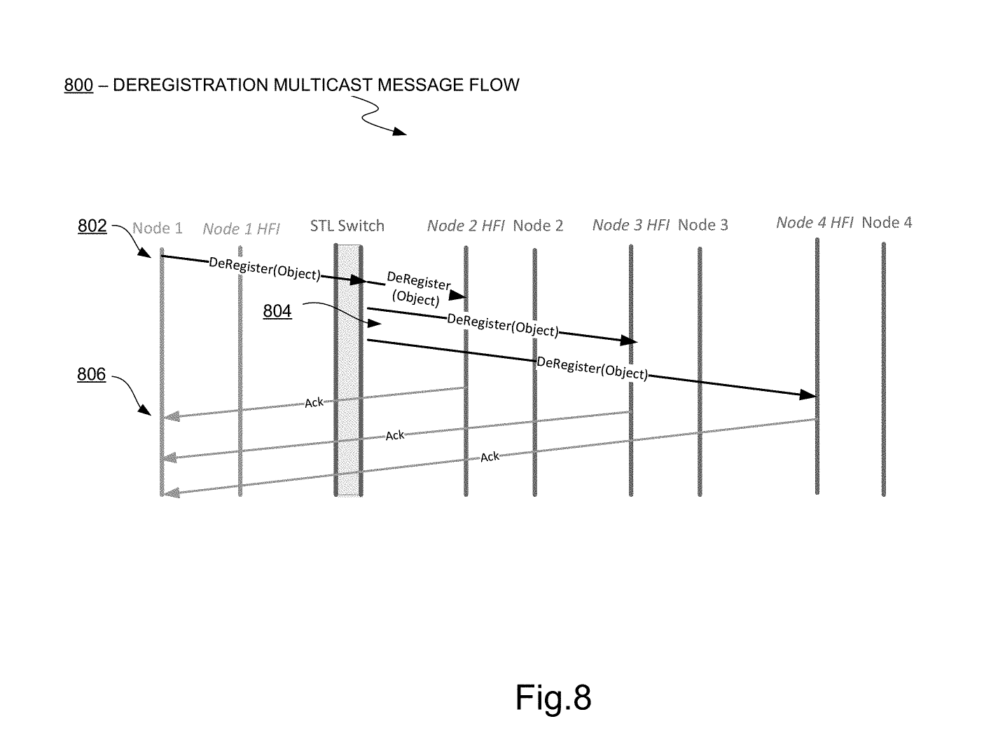

FIGS. 7-8 illustrate examples of message flows generated in accordance with embodiments of fabric-supported replication as shown in FIGS. 1-5. In a typical embodiment the message flows are implemented using transport layer (Layer 4 of the Open Systems Interconnection (OSI) model, also referred to as L4, en.wikipedia.org/wiki/OSI model) to avoid the need to make changes in other layers of the network architecture. In one embodiment, the message flows can be implemented in layers other than the transport layer L4, such as the network layer, L3.

In one embodiment, the interface to the nodes, referenced in FIGS. 7-8 by way of example only as Node 1 HFI, Node 2 HFI, Node 3 HFI and Node 4 HFI, is extended to process three new message flows, including software-directed registration message flows to the peer nodes, data payload messages to convey modifications to replicated objects, and deregistration messages to remove objects from replication at one or more replica nodes.

For example, for the software-directed registration message flows, a new PUT message is exposed to the software stack. In one embodiment, the message contains a Universal ID of the replicated object, a list of peer replica nodes for the replicated object, and the target node of the PUT message. In one embodiment, the new PUT message can also contain replication metadata characterizing the differences in the replicated object that need to be applied to the object's replicas at the peer replica nodes indicated in the list. In one embodiment, the replication metadata characterizing the differences describes how many modifications have been applied to the object batched in a single message.

In one embodiment, the data payload message is a PUT message generated in a node's interface to notify a remote node, i.e. one of the replica peer nodes to which the modified object is to be replicated, that the object has been modified. In one embodiment, this message includes various metadata and action(s) to be taken. The actions to be taken include instructing the remote node's interface to pull the modified object from the local node or, alternatively, to notify the software stack at the remote node to apply the modification to the object. In the former case the object replica at the remote node is discarded and replaced with the modified object pulled from the local node. In the latter case the object replica is modified at the remote node by the software stack using the modification data that is included in the data payload message.

In one embodiment, a deregister message is a multicast PUT message that the software stack can transmit to one or more replica nodes to deactivate monitoring of a previously monitored object at particular ones of the replica peer nodes. Responsive to receiving the deregister message the node logic removes the object from the monitoring table if necessary. In one embodiment, responsive to receiving the deregister message, the replica logic in the node's interface removes the replica peer node from the list of replica peer nodes to which the object was replicated, including removing the object from the replica table if there are no active replica peer nodes listed for the object.

With reference to FIG. 7, examples of the different types of message flows are illustrated. As shown in message flow 700, at 702 client node 1 sends a registration message to three different replication nodes specifying an object to be replicated, a list of replica nodes to which the object is to be replicated, and instructions whether to pull the replicated object from a node detecting a modification, or whether to apply one or more updates to the object that the software stack has accumulated. At 704, each of the registration messages is acknowledged back to the originating client node 1. At 706 replica node 4 detects that the replicated object has changed and, in turn, generates notification messages to replica nodes listed for the object, in this case replica node 3 and replica node 2.

With reference to FIG. 8, another example of a message flow is illustrated. As shown in message flow 800, at 802, the client node 1 transmits a deregistration message for a previously replicated object. At 804, the deregistration message is multicast to all of the replica nodes that were replicating the object on behalf of the software stack. A multicast message is a message that is simultaneously sent to multiple nodes. At 806, each of the replica nodes to which the deregistration message was multicast respond with acknowledgement messages, and the object is removed from the node and replica logic for each of the replica nodes, node 2, node 3 and node 4.

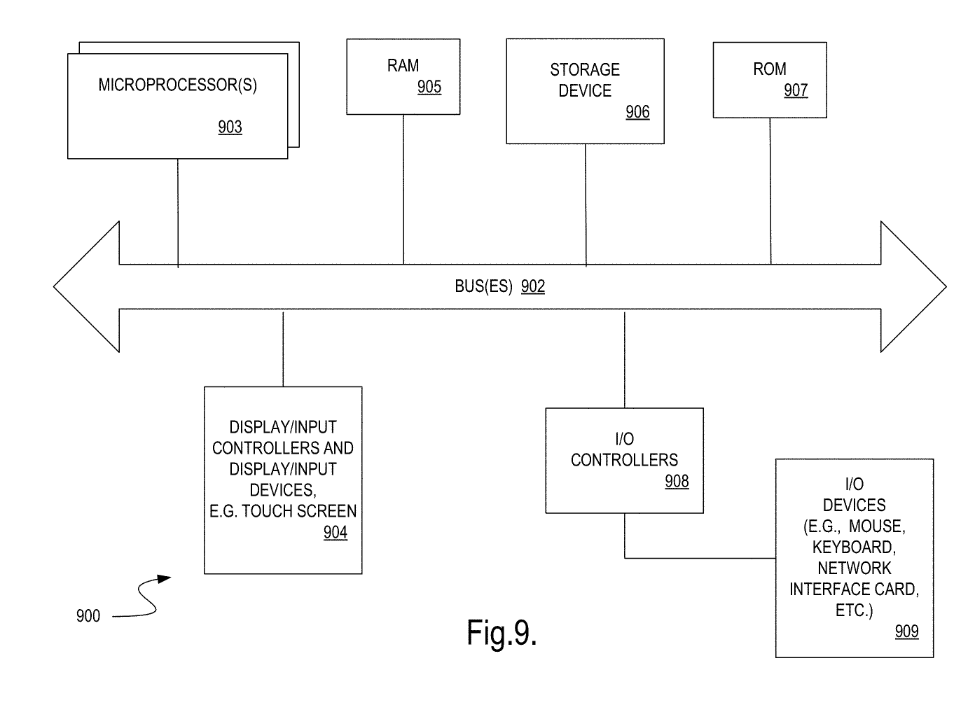

FIG. 9 illustrates an example of a typical computer system that can be used in conjunction with the embodiments described herein. Note that while FIG. 9 illustrates the various components of a data processing system 900, such as a computer system, it is not intended to represent any particular architecture or manner of interconnecting the components as such details are not germane to the described embodiments. It will also be appreciated that other types of data processing systems that have fewer components than shown or more components than shown in FIG. 9 could also be used with the described embodiments. The data processing system of FIG. 9 can be any type of computing device suitable for use as a forwarding device, switch, client, server and the like, of a storage management system. As shown in FIG. 9, the data processing system 900 includes one or more buses 902 that serve to interconnect the various components of the system. One or more processors 903 are coupled to the one or more buses 902 as is known in the art. Memory 905 can be DRAM or non-volatile RAM or can be flash memory or other types of memory described elsewhere in this application. This memory is coupled to the one or more buses 902 using techniques known in the art. The data processing system 900 can also include non-volatile memory, including ROM memory 907 and/or a storage device 906, such as a hard disk drive, solid state drive (SSD) or a flash memory or a magnetic optical drive or magnetic memory or an optical drive or other types of memory systems, all of which maintain data even after power is removed from the system. The non-volatile memory, such as ROM 907 and storage device(s) 906, and the memory 905 are coupled to the one or more buses 902 using known interfaces and connection techniques.

A display controller 904 is coupled to the one or more buses 902 in order to receive display data to be displayed on a display device 904 which can display any one of the user interface features or embodiments described herein. The display device 904 can include an integrated touch input to provide a touch screen.

The data processing system 900 can also include one or more input/output (I/O) controllers 908 which provide interfaces for one or more I/O devices, such as one or more mice, touch screens, touch pads, joysticks, and other input devices including those known in the art and output devices (e.g. speakers). The input/output devices 909 are coupled through one or more I/O controllers 908 as is known in the art.

While FIG. 9 shows that the non-volatile memory 907 and the memory 905 are coupled to the one or more buses directly rather than through a network interface, it will be appreciated that the data processing system may utilize a non-volatile memory which is remote from the system, such as a network storage device 906 which is coupled to the data processing system through a network interface such as a modem or Ethernet interface or wireless interface, such as a wireless WiFi transceiver or a wireless cellular telephone transceiver or a combination of such transceivers.

As is known in the art, the one or more buses 902 may include one or more bridges or controllers or adapters to interconnect between various buses. In one embodiment, the I/O controller 908 includes a Universal Serial Bus (USB) adapter for controlling USB peripherals and can control an Ethernet port or a wireless transceiver or combination of wireless transceivers.

It will be apparent from this description that aspects of the described embodiments could be implemented, at least in part, in software. That is, the techniques and methods described herein could be carried out in a data processing system in response to its processor executing a sequence of instructions contained in a tangible, non-transitory memory such as the memory 905 or the non-volatile memory 907 or a combination of such memories, and each of these memories is a form of a machine readable, tangible storage medium.

Hardwired circuitry could be used in combination with software instructions to implement the various embodiments. Thus the techniques are not limited to any specific combination of hardware circuitry and software or to any particular source for the instructions executed by the data processing system.

All or a portion of the described embodiments can be implemented with logic circuitry such as a dedicated logic circuit or with a microcontroller or other form of processing core that executes program code instructions. Thus processes taught by the discussion above could be performed with program code such as machine-executable instructions that cause a machine that executes these instructions to perform certain functions. In this context, a “machine” is typically a machine that converts intermediate form (or “abstract”) instructions into processor specific instructions (e.g. an abstract execution environment such as a “virtual machine” (e.g. a Java Virtual Machine), an interpreter, a Common Language Runtime, a high-level language virtual machine, etc.), and/or, electronic circuitry disposed on a semiconductor chip (e.g. “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture can be used to store program code. An article of manufacture that stores program code can be embodied as, but is not limited to, one or more memories (e.g. one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g. a server) to a requesting computer (e.g. a client) by way of data signals embodied in a propagation medium (e.g. via a communication link (e.g. a network connection)).

The term “memory” as used herein is intended to encompass all volatile storage media, such as dynamic random access memory (DRAM) and static RAM (SRAM) or other types of memory described elsewhere in this application. Computer-executable instructions can be stored on non-volatile storage devices, such as magnetic hard disk, an optical disk, and are typically written, by a direct memory access process, into memory during execution of software by a processor. One of skill in the art will immediately recognize that the term “machine-readable storage medium” includes any type of volatile or non-volatile storage device that is accessible by a processor.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The described embodiments also relate to an apparatus for performing the operations described herein. This apparatus can be specially constructed for the required purpose, or it may comprise a general-purpose computer selectively activated or reconfigured by a computer program stored in the computer. Either way, the apparatus provides the means for carrying out the operations described herein. The computer program can be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems can be used with programs in accordance with the teachings herein, or it may prove convenient to construct a more specialized apparatus to perform the operations described. The required structure for a variety of these systems will be evident from the description provided in this application. In addition, the embodiments are not described with reference to any particular programming language. It will be appreciated that a variety of programming languages could be used to implement the teachings of the embodiments as described herein.

In the foregoing specification, embodiments have been described with reference to specific exemplary embodiments. It will be evident that various modifications could be made to the described embodiments without departing from the broader spirit and scope of the embodiments as set forth in the following claims. The specification and drawings are, accordingly, to be regarded in an illustrative sense rather than a restrictive sense.

What is claimed is:

1. A computer-implemented method comprising:
in a communication fabric of a storage system for storing objects, the communication fabric having a plurality of nodes:
receiving a specification of an object and one or more replica peers to which the object is replicated, the replica peers specified from among the plurality of nodes; and
replicating the object to the one or more replica peers.

2. The computer-implemented method of claim 1, further comprising:
in the communication fabric:
detecting a modification of a replicated object in a node of the one or more replica peers specified from among the plurality of nodes;
notifying the one or more replica peers that the modification of the replicated object was detected; and
replicating the modification of the replicated object to a corresponding replicated object at the one or more replica peers.

3. The computer-implemented method of claim 2, wherein notifying the one or more replica peers that the modification of the replicated object was detected includes:
notifying the node that the modification of the replicated object was detected;
determining the one or more replica peers to which the replicated object is replicated; and
notifying each node of the determined one or more replica peers that the modification of the replicated object was detected.

4. The computer-implemented method of claim 2, wherein replicating the modification of the replicated object to the corresponding replicated object at the one or more replica peers includes any one of:
applying the modification to the corresponding replicated object at each of the one or more replica peers; and
replacing the corresponding replicated object at each of the one or more replica peers with the replicated object at the node in which the modification was detected.

5. The computer-implemented method of claim 2, wherein replicating the modification of the replicated object to the corresponding replicated object at the one or more replica peers is performed in accordance with a replica metadata, the replica metadata specifying one or more options for performing replicating, including any one or more of:
performing replicating immediately upon detecting the modification of the replicated object,
performing replicating after aggregating one or more modifications of one or more replicated objects within a specified time interval,
performing replicating by applying the modification at the replica peer,
performing replicating by replacing the replicated object at the replica peer, and
performing replicating in a software stack in communication with the replica peer.

6. The computer-implemented method of claim 1, wherein the specification of the object and the one or more replica peers to which the object is replicated is a registration message received in one node of the plurality of nodes, the registration message originating in a software stack in communication with the node.

7. The computer-implemented method of claim 6, further comprising updating the specification of the one or more replica peers to which the object is replicated via messages exchanged between the replica peers, wherein updating the specification of the one or more replica peers includes removing a specified one of the one or more replica peers from replication.

8. A system comprising:
a node in communication with a plurality of nodes, each node having a memory and a processor, the processor configured to receive a specification of an object and one or more replica peers to which the object is replicated, the replica peers specified from among the plurality of nodes;
the processor further configured to:
store the specification in a replication data structure mapping the object to the one or more replica peers;
replicate the replication data structure to the one or more replica peers; and
replicate the object to the one or more replica peers.

9. The system of claim 8 wherein the processor is further configured to:
notify the one or more replica peers that a modification of a replicated object was detected; and
replicate the modification of the replicated object to a corresponding replicated object at the one or more replica peers.

10. The system of claim 9, further comprising an interface in each node of the plurality of nodes, the interface supporting communications between each node of the plurality of nodes and between each node and a communication fabric of the plurality of nodes, the interface configured to:
access the replication data structure mapping the replicated object that was modified to the object's one or more replica peers;
notify each node of the object's one or more replica peers that the modification of the replicated object was detected.

11. The system of claim 9, wherein to replicate the modification of the replicated object to the corresponding replicated object at the one or more replica peers, the processor is further configured to:
apply the modification to the corresponding replicated object at each of the one or more replica peers; and
replace the corresponding replicated object at each of the one or more replica peers with the replicated object at the node in which the modification was detected.

12. The system of claim 9, wherein to replicate the modification of the replicated object to the corresponding replicated object at the one or more replica peers, the processor is further configured to receive, along with the specification of the object and the one or more replica peers to which the object is replicated, a replica metadata, the replica metadata specifying one or more options for replicating, including any one or more of options to:
replicate immediately upon detecting the modification of the replicated object;
replicate after aggregating one or more modifications of one or more replicated objects within a specified time interval;
replicate by applying the modification at the replica peer,
replicate by replacing the replicated object at the replica peer, and
replicate in a software stack in communication with the replica peer.

13. The system of claim 8, wherein the specification of the object and the one or more replica peers to which the object is replicated is a registration message received in one node of the plurality of nodes, the registration message originating in a software stack in communication with the node.

14. The system of claim 8, wherein the processor is further configured to update the specification of the one or more replica peers to which the object is replicated via messages exchanged between the replica peers, wherein updating the specification of the one or more replica peers includes removing a specified one of the one or more replica peers from replication.

15. At least one computer readable storage medium including instructions that, when executed on a machine, cause the machine to:
receive a specification of an object and one or more replica peers to which the object is replicated, the replica peers specified from among a plurality of nodes; and
replicate the object to the one or more replica peers.

16. The at least one computer readable storage medium of claim 15, the instructions further causing the machine to:
detect a modification of a replicated object in a node of the one or more replica peers specified from among the plurality of nodes;
notify the one or more replica peers that the modification of the replicated object was detected; and
replicate the modification of the replicated object to a corresponding replicated object at the one or more replica peers.

17. The at least one computer readable storage medium of claim 16, wherein the instructions causing the machine to notify the one or more replica peers that the modification of the replicated object was detected further causing the machine to:
notify the node that the modification of the replicated object was detected;
determine the one or more replica peers to which the replicated object is replicated; and
notify each node of the determined one or more replica peers that the modification of the replicated object was detected.

18. The at least one computer readable storage medium of claim 16, wherein the instructions causing the machine to replicate the modification of the replicated object to the corresponding replicated object at the one or more replica peers further causes the machine to perform any one of:
apply the modification to the corresponding replicated object at each of the one or more replica peers; and
replace the corresponding replicated object at each of the one or more replica peers with the replicated object at the node in which the modification was detected.

19. The at least one computer readable storage medium of claim 16, wherein the instructions causing the machine to replicate the modification of the replicated object to the corresponding replicated object at the one or more replica peers is performed in accordance with a replica metadata, the replica metadata specifying one or more options for performing replicating, including any one or more of:
performing replicating immediately upon detecting the modification of the replicated object,
performing replicating after aggregating one or more modifications of one or more replicated objects within a specified time interval,
performing replicating by applying the modification at the replica peer,
performing replicating by replacing the replicated object at the replica peer, and
performing replicating in a software stack in communication with the replica peer.

20. The at least one computer readable storage medium of claim 15, wherein the specification of the object and the one or more replica peers to which the object is replicated is a registration message received in one node of the plurality of nodes, the registration message originating in a software stack in communication with the node.

21. The at least one computer readable storage medium of claim 20, wherein the instructions causing the machine to replicate the object to the one or more replica peers causes the machine to update the specification of the one or more replica peers to which the object is replicated via messages exchanged between the replica peers, wherein to update the specification of the one or more replica peers includes to remove a specified one of the one or more replica peers from replication.
